(19) United States
(12) Patent Application Publication
(10) Pub. No.: US 2003/0058959 A1
(43) Pub. Date: Mar. 27, 2003

(54) Combined digital adaptive pre-distorter and pre-equalizer system for modems in link hopping radio networks

(75) Inventors: Manouchehr S. Rafie, Sunnyvale, CA (US); Jun Lu, San Jose, CA (US); Mark Edward Snesrud, Cupertino, CA (US)

Correspondence Address: BRINKS HOFER GILSON & LIONE, P.O. Box 10395, Chicago, IL, 60610, US

(73) Assignee: Caly Networks.

(21) Appl. No.: 09/964,200

(22) Filed: Sep. 25, 2001

(51) Int. Cl. H04K 1/02

(52) U.S. Cl. 375/296

(57) ABSTRACT

A method for a combined adaptive digital pre-distorter and pre-equalizer apparatus in single- and/or multiple-link hopping radio systems including hopping among a plurality of radio links to transmit variable-length bursts of radio signals on the plurality of radio links. Further, pre-distorting amplitude and phase of transmitted signal constellations based on the inverse AM-to-AM and AM-to-PM characteristics and the operating conditions of the high-power amplifier, respectively. Further, pre-equalizing amplitude and group-delay variations of the transmit RF radio using the pre-stored estimated complex tap coefficient of the pre-equalizer under different frequency bands.

### BACKGROUND OF THE INVENTION

The present invention relates generally to radio transmitters. More particularly, this invention relates to a combined digital pre-distorter and pre-equalizer subsystem employed in fixed broadband wireless access (FBWA) applications using variable-length-burst modems with a nonlinear front-end radio with memory operating in multi-link hopping mesh radio networks over slow time-varying channels. The radio frequency (RF) front end of transmit node of the network employs a high-power amplifier (HPA) with a nonlinear amplitude-to-amplitude (AM/AM) and amplitude-to-phase (AM/PM) characteristics, respectively. The transmit mode RF front end includes a number of band-limited cascaded filters resulting in an undesired inter-symbol interference (ISI) prior to the HPA. Hence, the nonlinearity of the HPA is assumed to have memory.

The embodiments described herein may be used in conjunction with a wireless mesh topology network of the type described in U.S. patent application Ser. No. 09/187,665, entitled “Broadband Wireless Mesh Topology Networks” and filed Nov. 5, 1998 in the names of J. Berger and I. Aaronson, with carrier phase recovery system described in U.S. patent application Ser. No. (TBD), entitled “Carrier Recovery System for Adaptive Modems and Link Hopping Radio Networks” and filed in the names of M. Rafie et al., and with network nodes including switched multi-beam antenna designs similar to the design described in U.S. patent application Ser. No. 09/433,542, entitled “Spatially Switched Router for Wireless Data Packets” and filed in the names of J. Berger, et al., as well as with the method and apparatus disclosed in U.S. patent application Ser. No. 09/699,582 entitled “Join Process Method For Admitting A Node To A Wireless Mesh Network, filed Oct. 30, 2000, in the names of Y. Kagan, et al. Each of these U.S. patent applications is incorporated in its entirety herein by reference. Other applications for the embodiments will be apparent from the description herein.

Burst transmission of digital data is employed in several applications such as satellite time-division multiple access, digital cellular radio, wide-band mobile systems and broadband wireless access systems. The design trade-offs, their affect on performance; and the resulting architectures are different in each of these applications.

A constant need for ever-increasing throughputs through fixed bandwidths, fueled by broadband Internet Protocol (IP) applications, has pushed system designers toward more throughput-efficient modulation schemes. Spectrally-efficient linear modulation techniques such as M-ary quadrature-amplitude modulations (M-QAM) are highly in demand in broadband wireless applications due to explosive growth in number of users and broadband services such as high-speed data and multimedia. However, due to the use of high-power amplifiers (HPA) for longer range and better carrier-to-interference (C/I) requirements, the in-band transmitted high-level QAM signal is distorted and the spectrum is spread into out-of-band channels because of the nonlinearity of the amplifier. In order to reduce the impact of nonlinear distortion of a HPA when it is operated in its near-peak capacity, in some applications the input is backed off from saturation point and is operated in a so-called linear region. This causes the amplifier to be less efficient and the output transmit power may not be adequate for certain applications. Typically in wireless applications, this will result in a shorter range and hence a more expensive HPA with a higher 1-dB compression point (P1) to deliver the required output transmit power.

Although operating in the linear region of an amplifier characteristic helps to circumvent the amplitude distortion, the phase distortion in linear modulation schemes such as M-QAM is yet of a great concern. In most of the reported papers, the pre-distorter is based on an analog cubic pre-distorter filter, or the nonlinearity is assumed to be memoryless and frequency independent. Digital pre-distortion techniques could be implemented to restrict spectral spreading and adjacent channel interference through compensating the nonlinear characteristics of the amplifier.

There are several approaches to linearization and pre-distortion techniques. The majority of linearizers are implemented through analog techniques. Digital linearizers are also described in the literature, mostly focused on issues of spectral regrowth. In the reported papers pertaining to the digital pre-distorted techniques, look-up tables are implemented immediately before the amplifier in the transmitter architecture. The look-up tables are used to adjust the input signal by the inverse characteristics of the amplifier. Thus, the cascade combination of the pre-distorter and the HPA produces more linear characteristics.

There are also a number of different configurations for combined linearizers/pre-distorters. The most well-known (and mature) linearizer is the feedforward architecture. Its general configuration is the easiest to implement even at high frequencies. Analog feedforward linearization reduces spectral regrowth by canceling the distortion components at the output of the nonlinear amplifier. A block diagram of an analog feedforward system is shown in FIG. 1.

FIG. 1 is a block diagram of a prior art feedforward analog linearizer 100. The linearizer 100 includes an amplification branch 102 and an auxiliary branch 104. The amplification branch 102 includes a high-power amplifier (HPA) 106 and a delay line 108. The auxiliary branch 104 includes a delay line 110, an attenuator 112 and an auxiliary high power amplifier 114. An attenuator 116 is coupled to a coupler 118 at the output of the HPA 106 to produce an attenuated signal. An input of the delay line 110 is coupled to the RF input 124 to receive the input signal at the RF input 124. The delay line 110 produces a delayed input signal. A second coupler 120 combines the attenuated signal at the attenuator 116 with the delayed input signal at the delay line 110. The attenuator 112 introduces substantially the same attenuation as the attenuator 116. The delay line 108 introduces substantially the same delay as the delay line 110. The auxiliary amplifier 114 amplifies the combined signal by substantially the same amplification as the HPA 106. A coupler 126 combines the signal in the auxiliary branch 104 with signal in the amplification branch 102 to eliminate nonlinearities in the signal at the RF output 128.

The linearizer 100 of FIG. 1 reduces spectral re-growth by canceling the distortion components at the output of the nonlinear power amplifier. The linearizer 100 of FIG. 1 is composed of two loops. The first loop cancels the signal and the second loop cancels the distortion. In the first loop, the power amplifier 106 in the upper or amplification branch introduces nonlinearity. The coupler 118 samples part of the distorted output signal from the amplifier 106 and adds the signal to the lower branch 104. The delay lines 108, 110 are adjusted to give 180 degrees of phase rotation. In the second loop the distortion components are canceled, leaving only the desired signal. The feed-forward structure of FIG. 1 has excellent results, over 20 dB of cancellation of the third order inter-modulation distortion components (IMD's). However, this configuration is not adaptive and requires an extra power amplifier. The linearizer 100 is thus sensitive to imbalances in the two loops.

The feedforward approach takes a sample from the amplifier output and removes the main signal leaving only the distortion products and subtracts this distortion signal from the output. The main disadvantage of this configuration is that it is not adaptive and requires extra components, fine adjustments, extra power for losses introduced on the desired signal and an extra power amplifier to generate the distortion signal. Additionally, phase and amplitude balances are very sensitive in this design. The configuration can be modified and made adaptive with additional complexity at the RF frequencies. The adaptive design might not be appropriate for millimeter range frequencies.

A pre-distorter is also a linearizer where the input signal to the nonlinear device is pre-distorted in such a way the overall cascaded pre-distorter and HPA characteristics is linear. Pre-distortion can be performed at RF, IF, or at the baseband. The block diagram of a typical pre-distorter is shown in FIG. 2.

FIG. 2 is a block diagram of a pre-distorter and high-power amplifier system 200. The system 200 is an example of a prior art pre-distorter system that is commonly used to linearize or pre-distort a transmit signal. The system 200 includes a pre-distorter 202, high-power amplifier (HPA) 204, a control processor 206, a coupler 208 and an antenna 210. The control processor 206 receives the input RF signal x(t) and an output RF signal from the coupler 208. The control processor 206 determines the distortion that must be introduced by the pre-distorter 202 to cancel distortion introduced by the HPA 204. Plot 212 shows the non-linear signal response transfer function of the HPA 204. Plot 214 shows the transfer function of the pre-distorter 202 under control of the control processor 206 developed to compensate the HPA 204 distortion, plot 212. Plot 216 shows the resulting linear transfer function for the circuit 200.

The system 200 of FIG. 2 can be implemented either digitally or in an analog domain. In most of the reported systems, the HPA immediately follows the pre-distorter. The control processor unit 206 generates a signal, z(t) to help to produce the required inverse HPA characteristics at the pre-distorter 202. In feedback configurations, the directional coupler 208 is also provided to sample the output of the HPA 204 a·\hat{x}(t). The sampled signal is fed back to the control processor 206 for use in an adaptive algorithm performed to track the dynamic behavior of the nonlinear device HPA 204.

The ideal characteristics of the pre-distorter, HPA, and the cascaded blocks (pre-distorter and HPA) are shown in plots 214, 212, and 216 of FIG. 2, respectively. The pre-distorter 202 can successfully correct up to the full saturation level of the amplifier 204. With the pre-distorter 202, the amplifier is allowed to be at an operating point much closer to saturation since the distortion in the peaks can be corrected up to the saturation level. In plot 212, the intersection 218 of the linear response and the saturation limit is the maximum amplitude allowed for correction with pre-distortion. The resulting characteristic shown in plot 216 behaves (ideally) as a soft limiter. The amplifier must be backed off from its saturation level an amount equal to the peak-to-average level of the signal for distortion-free characteristics.

As amplifier input power is increased, output power of the amplifier has a linear gain until the output power is saturated. The maximum power occurs at saturation where that amplifier is driven into the nonlinear region of the AM/AM and AM/PM characteristics, f(.) and g(.), respectively. Given the transmitted input signal x(t),

x(t)=R(t)cos[2πf₀t+θ(t)]

where R(t) and θ(t) are amplitude and phase of input signal, respectively. The output of the nonlinear amplifier is as follows,

y(t)=f[R(t)]cos[2πf₀t+θ(t)+g(R(t))]

The pre-distorted signal,

y(t)=\hat{f}⁻¹[R(t)]·cos(2πf₀t−ĝ[R(t)]+θ),

is fed into the HPA with a gain of, a, resulting in the following signal,

s(t)=a·f └\hat{f}⁻¹[R(t)]┘·cos(2πf₀t+g[R(t)]−ĝ[R(t)]+θ)=a·\hat{x}(t).

An alternative linearizer configuration has a feedback structure. There are several possible designs in this configuration. Traditionally, most of the feedback systems are analog such as those implementing the Cartesian feedback algorithm. Recently, there have been feedback designs where in which the feedback path extends to the digital baseband portion of the transmitter.

Conventional pre-distortion techniques ignore the impact of inter-symbol interference (ISI) distortion induced by the band-limited filters between the pre-distorter and the nonlinear device and are primarily used for point-to-point radio communication systems.

Hence, there is a need for a method and apparatus for a combined digital pre-distorter and pre-equalizer that when cascaded with a nonlinear amplifier with memory would result in overall linear characteristics. This is highly desirable in conjunction with broadband and spectrally-efficient modulation schemes. Further, there is a need for a method and apparatus for a combined digital pre-distorter and pre-equalizer technique in a link-hopping system for multi-link radio communication systems when operated in a mesh network.

### BRIEF SUMMARY

By way of introduction only, the present embodiments provide method and apparatus for transmitting radio signals in a single- and/or multiple-link hopping radio systems. The methods include transmitting over a single link and/or hopping among a plurality of radio links to transmit bursts of signals. Embodiments in accordance with the present invention are capable of digital pre-distortion for nonlinear AM/AM and AM/PM distortions as well as pre-compensation of ISI due to the band-limiting impact of the transmit analog filters for each radio link. Further, the methods include storing the calculated inverse AM/AM and AM/PM characteristics for different temperature values through a calibrated ramp signal.

The embodiments further provide a digital pre-equalizer method and system for use in a multiple-link hopping, burst adaptive modem. The system comprises a programmable, fixed fractionally-spaced equalizer configured to pre-equalize a present burst of data using pre-stored equalizer weights that are generated through a calibrated adaptive equalizer for a transmit radio link.

The embodiments further provide a method for transmitting radio signals that includes transmitting a first burst on a first radio link with a pre-calculated HPA operating point for the first burst of the active link based on the modulation scheme and operating distance of the radio link. The method further includes transmitting a next burst such as a second burst of the first radio link using the pre-assigned HPA operating point for the second burst of the first radio link based on the QAM modulation level.

The embodiments further provide a combined digital pre-distorter and pre-equalizer method for use in a multiple-link hopping, burst adaptive modem. The method includes transmitting adaptive modulated M-QAM signals as a series of bursts on multiple links each having a designated HPA operating point per link.

An alternative embodiment further provides a feedback path from the output of the HPA to the transmitter to enable the pre-distorter lookup tables to be updated on the fly. A simple mean-squared error (MSE) adaptive algorithm, employing the distorted feedback signal and the undistorted transmit symbols, generates the updates for the lookup tables.

The foregoing discussion of the preferred embodiments has been provided only by way of introduction. Nothing in this section should be taken as a limitation on the following claims, which define the scope of the invention.

### BRIEF DESCRIPTION OF THE SEVERAL VIEWS OF THE DRAWINGS

FIG. 1 is a block diagram of a analog (a prior art) linearizer;

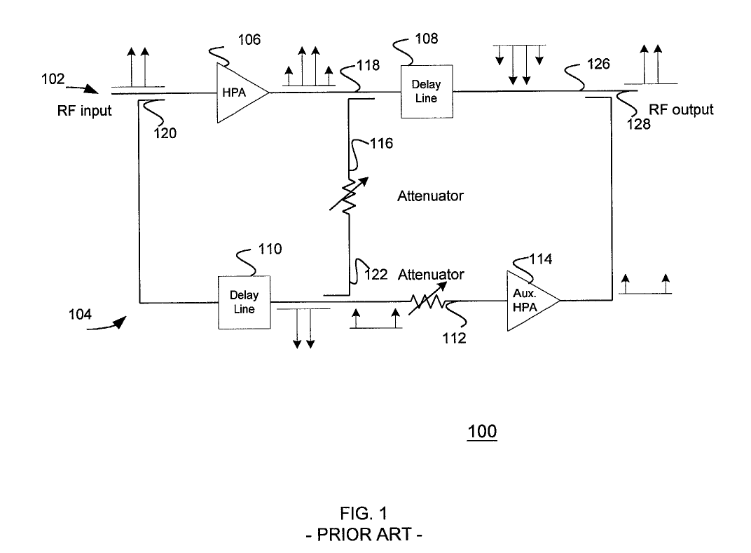

FIG. 2 is a canonical block diagram of a prior art including a pre-distorter, a HPA, and an adaptive processor or compensator;

FIG. 3 is a block diagram of a link hopping wireless network having a mesh topology;

FIG. 4 is a block diagram of a pre-distorting circuit employing a lookup table;

FIG. 5 illustrates a pre-distorter apparatus for use in a transmitter of the network of FIG. 3;

FIG. 6 illustrates an implementation of a pre-distorter circuit for use in a transmitter of the network of FIG. 3;

FIG. 7 is a block diagram of a calibration system for generating entries for the pre-distorter table lookup tables;

FIG. 8 is a block diagram of a fixed and programmable fractionally-spaced pre-equalizer;

FIG. 9 is a block diagram of a calibration system for the pre-equalizer of FIG. 8;

FIG. 10 is a block diagram of a transmitter circuit incorporating a digital pre-distorter and pre-equalizer;

FIG. 11 illustrates an alternative embodiment of a transmitter circuit incorporating a digital pre-distorter and pre-equalizer;

FIG. 12 illustrates the amplitude-amplitude characteristics of a high power amplifier before and after pre-distortion along with input back-off requirements;

FIG. 13 illustrates actual measured amplitude-amplitude characteristics of a high power amplifier before and after pre-distortion; and

FIG. 14 illustrates in-band and out-of-band distortion before and after the use of pre-distortion with a high power amplifier.

### DETAILED DESCRIPTION OF THE PRESENTLY PREFERRED EMBODIMENTS

A method for a combined programmable digital pre-distorter and pre-equalizer apparatus may be used in single-or multiple-link hopping wireless systems that includes hopping among a plurality of radio links. In a node of the system, a modem transmits pre-distorted variable M-QAM modulated bursts on a burst-to-burst basis for each radio link. The digital transmitter pre-equalizes the pre-distorted signal to pre-compensate for any undesired amplitude and group delay variations of the linear components preceding the nonlinear power amplifier.

The signal processing methods and apparatus use a pre-distorter consisting of lookup tables that are programmable conditioned upon the selected operating link and the modulation scheme employed per burst. A fixed fractionally-spaced pre-equalizer is also implemented to compensate for any amplitude and group delay variations of the front-end radio prior to the HPA of the transmitter.

The performance of the pre-distorter block highly depends on the accurate characterization of the nonlinear device(s). Hence, the AM/AM and AM/PM characteristics of the HPA should be first extracted through a calibration setup. Initially, a ramp signal is used to drive the HPA and to extract the distortion characteristics of the amplifier. Then, an inversion operation is performed on the estimated AM/AM and AM/PM distortion characteristics of the power amplifier and resulting vectors are stored in two lookup tables.

The present embodiments relate to a digitally programmable pre-distorter and pre-equalizer unit for a link-hopping wireless mesh topology architecture used for fixed broadband wireless access networks. Such networks operate in different spectra such as in the Local Multi-point Distributed Service (LMDS) band at 28 GHz. The modem of a node in such a network is capable of fast link hopping from one link to another over slow time-varying channels. That is, the channel is quasi-static from burst to burst for any given link.

The present embodiments are designed to enhance performance as compared to traditional pre-distorter schemes through employing fast and efficient algorithms suitable for variable-length burst modems with variable-QAM modulation signaling and multi-hopping radio links, while maintaining low-implementation complexity and high-throughput efficiency. A digital pre-distorter technique along with a pre-equalizer subsystem are within the scope of this embodiment. The present embodiment pre-distorts the transmitted signal vector constellations and pre-compensates for amplitude and group-delay distortions of the transmitted signal in order to minimize the in-band and out-of-band signal distortions in dynamic mesh networks employing high-speed, variable-length burst data using adaptive QAM modulation schemes. Apparatus and method in accordance with the present invention can be easily used for point-to-point or point-to-multi-point topologies, as well.

To provide a high-performance radio link for high-speed systems employing spectrally-efficient modulation schemes, a reliable and robust transmitter radio link is required. Present embodiments of the current invention perform signal processing techniques to enhance the system performance and robustness of the transmitter portion of the transceiver. First, the M-ary QAM signal constellations are pulse shaped and pre-distorted using pre-calculated and pre-stored AM/AM and AM/PM characteristics of the HPA (i.e., \hat{f}⁻¹(.) and −ĝ(.)). Next, the pre-distorted signal is pre-conditioned using a programmable pre-equalizer to compensated for undesired amplitude and group variations of the linear components of the transmit radio preceding the HPA. When a new burst of a particular link is transmitted in a mesh topology (multi-point to multi-point), the operating point of the HPA is calculated based on the modulation scheme used per burst, and the operating distance for the active radio link. The pre-estimated and pre-stored tap coefficients of the pre-equalizer are used in a fixed FIR filter structure. In this embodiment, K-tap coefficients, C=[c(0) c(1) [symbol] c(K−1)]^{T}, of the fixed pre-equalizer are loaded from a memory unit into a T/M-spaced filter. Further, in the present embodiments, each node has N sets of tap coefficients stored in its local memory corresponding to N possible frequency selections (for small N, N≦3).

The present embodiments provide novel and improved methods and systems for employing a combined digital pre-distorter and pre-equalizer. The present invention can operate in two distinct configurations. In the first configuration of the embodiment of the present invention, the system operates in a feedforward mode wherein all parameters are pre-calculated and pre-stored through a calibration system. The advantage of this embodiment is that, the system enjoys a relatively simple, efficient, and low-cost implementation. However, multiple lookup tables are provided for different scenarios based on the dynamic behavior of the undesired distortion.

In a second embodiment of the present invention, the pre-distorter structure is made adaptive and is updated through a feedback path where a directional coupler at the output of the HPA samples the RF signal and the resulting sample is fed back to a digital signal processor for appropriate adjustment needed in the LUT (look-up table). One advantage of this embodiment is that it is fairly robust and adapts itself to any possible changes of the characteristics of the HPA. However, this configuration may increase complexity and implementation cost.

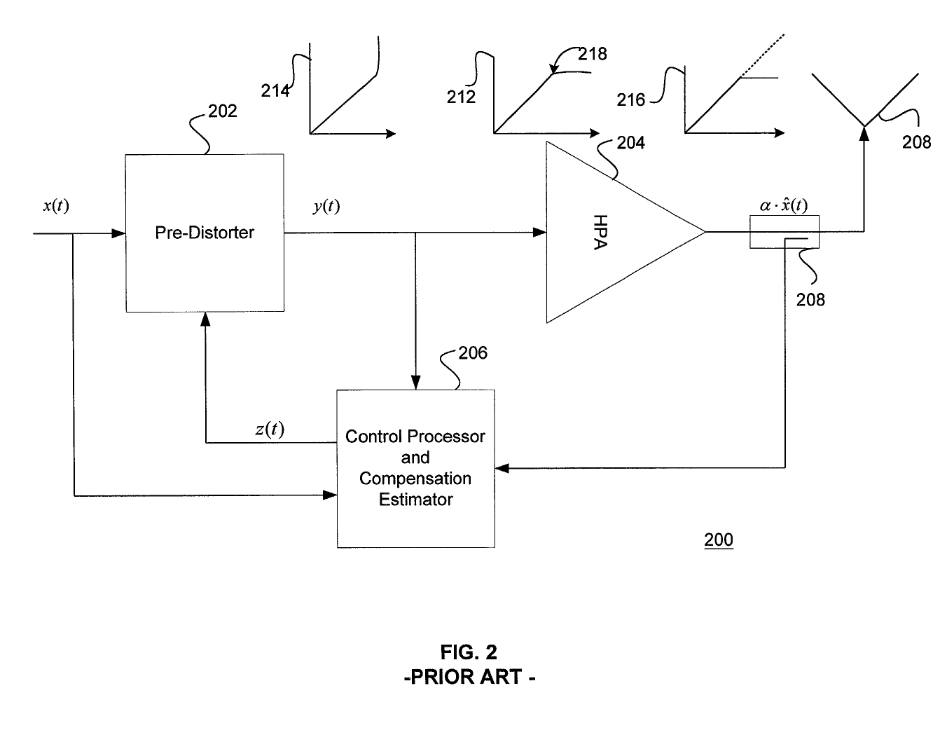

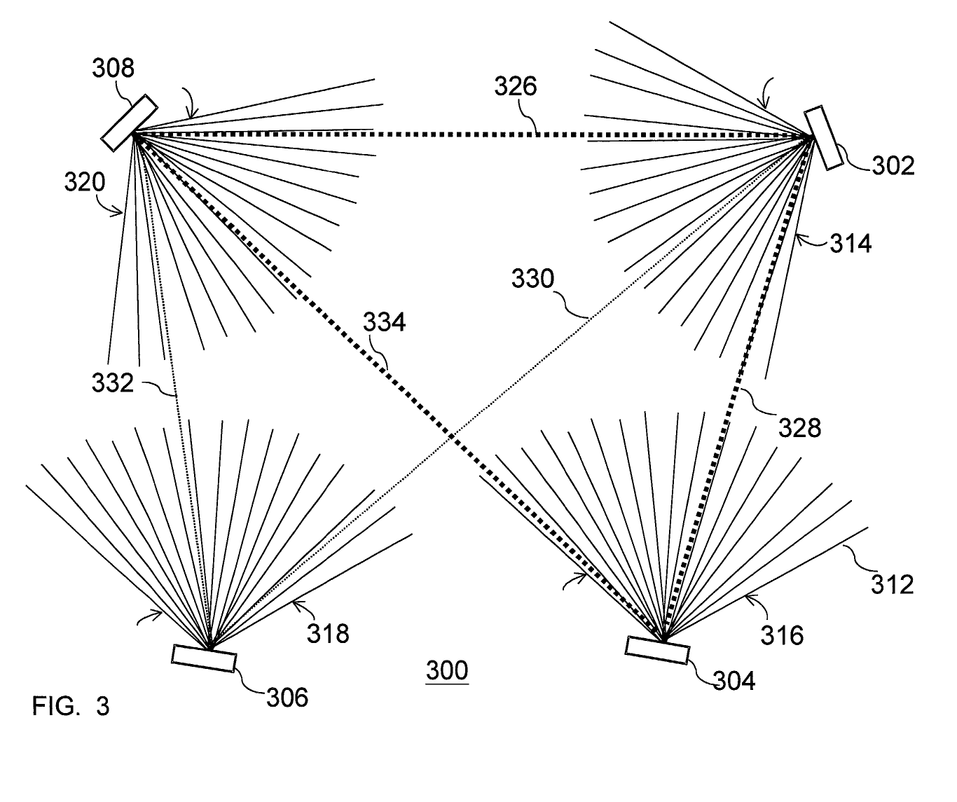

FIG. 3 is a block diagram of an exemplary wireless radio network 300 employing a mesh topology. The network 300 as illustrated in FIG. 2 includes a first node 302, a second node 304, a third node 306 and a fourth node 308 in radio communication. The network 200 may include any number of nodes. The four nodes shown in FIG. 3 are exemplary only. In the embodiment of FIG. 3, the network 300 is a wireless mesh topology network of the type described in U.S. patent application Ser. No. 09/187,665, entitled “Broadband Wireless Mesh Topology Networks” and filed Nov. 5, 1998 in the names of J. Berger and I. Aaronson.

Each node 302, 304, 306, 308 includes data processing apparatus and a radio for communication of data with remote radios, such as other nodes of the network 300. Each node in the exemplary embodiment includes a directional antenna that provides radio communication on a number of sectors. The sectors provide radio coverage over a portion of the geographic area near a node. Thus, node 304 includes sectors 312 providing coverage over an area 316 which includes node 302. Node 302 provides coverage over an area 314. Node 306 provides coverage over an area 318, and node 308 provides coverage over an area 320.

Nodes 302, 304, 306, 308 of the network 300 are considered peers. They are free to communicate with one another on an equal basis. This is in distinction to a hierarchical system such as base stations communicating with subscriber units in a cellular radiotelephone system. Communication among the nodes 302, 304, 306, 308 is peer-to-peer communication.

Two nodes are in radio communication when their antenna sectors align. In that case, the nodes may complete a radio link and exchange data and control information. Thus, node 302 and node 304 communicate on link 328, node 302 and node 308 communicate on link, and node 304 and node 308 communicate on a link 334.

The fixed broadband wireless network 300 operates in two modes. A first mode is referred to as the acquisition or join mode. A second mode is referred to as the steady-state or burst mode. In the first mode of operation, the node obtains an accurate estimate of the channel parameters using a join packet transmitted from another node. The join process may be of the type described in U.S. patent application Ser. No. 09/699,582 entitled “Join Process Method For Admitting A Node To A Wireless Mesh Network,” filed Oct. 30, 2000 in the names of Y. Kagan, et al.

In the exemplary embodiment of FIG. 3, node 306 may be considered a joining node which is in the process of joining the network 300 including existing nodes 302, 304, 308. The joining node 306 receives invitation packets from the existing nodes 302, 304, 308 and can thus establish radio communication with node 302 on a link 330 and with node 308 and on a link 332.

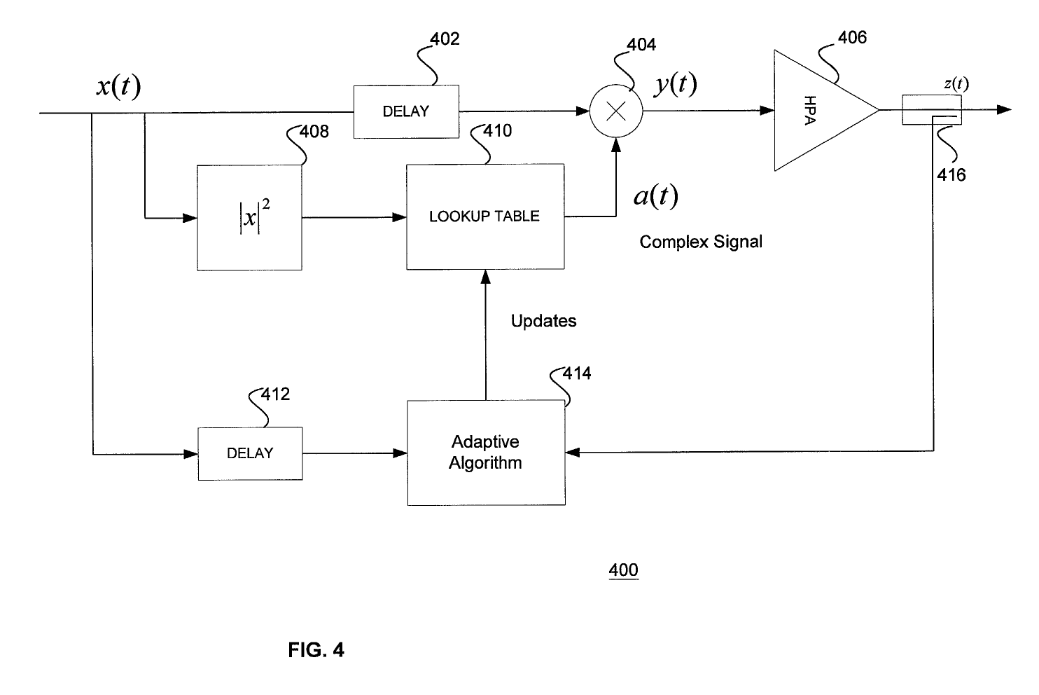

FIG. 4 is a block diagram of a pre-distorting circuit 400 employing a lookup table. The circuit 400 includes a delay block 402, a combiner 404 and a high power amplifier (HPA) 406. The circuit 400 further includes a power estimator 408, a lookup table 410, a delay block 412, a processor 414 and a coupler 416. The delay block 402 delays the received input signal x(t). The power of the input signal x(t) is estimated by the block 408 and used to index the lookup table block 410 to produce the instantaneous complex distortion gain, a(t). This gain is applied to the original signal, x(t) in the multiplier 404. The output signal y(t) from the multiplier 404 is provided to the HPA 406. The output signal z(t)of the HPA will have the desired (linear) characteristics.

In one embodiment shown in FIG. 4, feedback may be used in conjunction with an adaptive algorithm implemented by the processor 414. In the feedback embodiment, the output signal z(t) is sampled at the coupler 416. The output signal z(t) is fed back to the processor 414. The delay block 412 produces a delayed version of the input signal x(t). This delayed version of the input signal, x(t), is provided to the processor 414. The combination of reference signals, x(t) and z(t) are used to aid the processor 414 implementing the adaptive algorithm to continuously update the lookup table 410.

This embodiment is primarily constructed using digital circuits. Examples include digital memory such as RAM for the lookup table 410 and a digital signal processor for the processor 414.

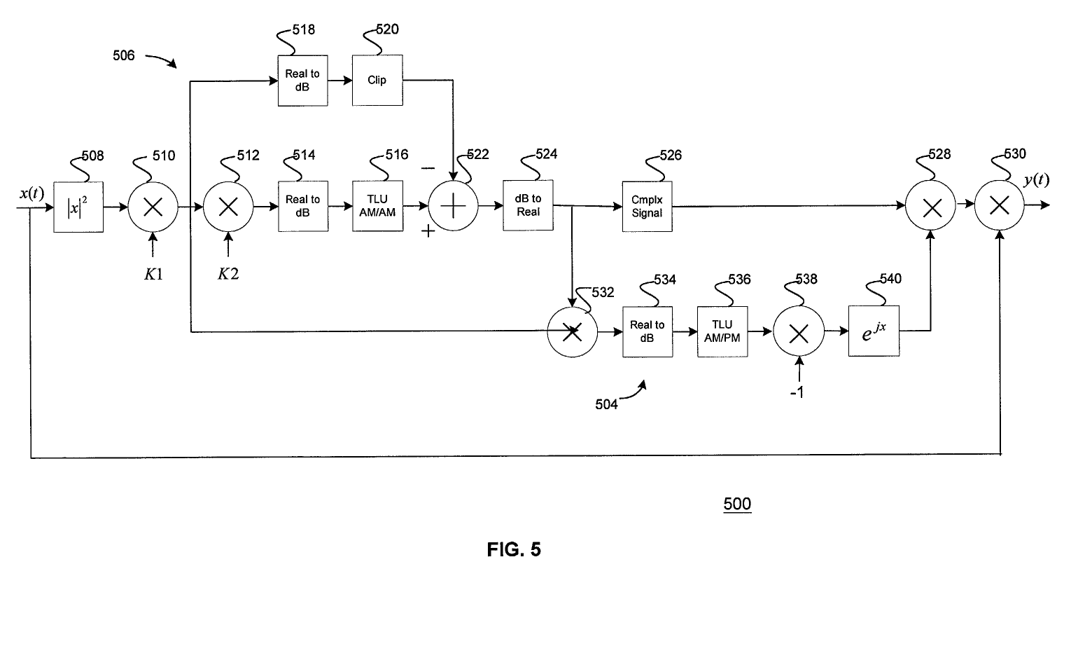

FIG. 5 shows one embodiment of a digital pre-distorter 500. The pre-distorter 500 includes an input circuit 502, an amplitude-to-amplitude circuit 504 and an amplitude-to-phase circuit 506. The input circuit includes a power estimator 508 and a normalizer 510.

The amplitude-to-amplitude circuit 504 includes a scaler 512, a real to logarithmic converter 514 and an inverse AM/AM lookup table block 516. The amplitude-to-amplitude circuit 504 further includes a real to logarithmic converter 518, a clipper 520, a subtracter 522 and a logarithmic to real converter 524.

The amplitude-to-phase circuit 506 includes a real to complex signal converter 526, a multiplier 528 and a multiplier 530. The amplitude-to-phase circuit 506 further includes a multiplier 532, a real to logarithmic converter 534, an amplitude-to-phase table lookup block 536, a multiplier 538 and a phase calculator 540.

The incoming signal power is first calculated by the power estimator 508. The power is normalized by the normalizer 510 based on the average power of the transmitted modulation format, K1. The signal is then scaled by the scaler 512, accounting for the gain, K2, of the high power amplifier for the system (not shown). The real to logarithmic converter 514 coverts the signal power to dB to match the entry format of the inverse AM/AM lookup table 516. The output signal of the real to logarithmic converter 514 is coupled to the inverse AM/AM lookup table block 516 to index the tables for appropriate selection of the distortion values, \hat{f}⁻¹[R(t)].

The output signal from the normalizer 510 is also provided to the real to logarithmic converter 518 for proper real-to-dB conversion. The converted signal is clipped by the clipper 520 to confine the signal to the dynamic range of the digital-to-analog converter (DAC) of the transmitter (not shown). The signal is then scaled by the subtractor 522 and converted back to real domain by the logarithmic to real converter 524. The output of the inverse AM/AM lookup table block 516 in effect is subtracted from the output signal of the clipper 520 through the subtracter 522 to limit the inverse gain characteristic to a pre-determined dynamic range of the transmitter DAC. The output signal of block 524 is converted into a complex signal through the complex signal converter 526.

The normalized power signal from the normalizer 510 is now adjusted by the generated distorted gain using the output signal from the logarithmic to real converter 524 at the real multiplier block 532. The resulting signal is used to generate the required AM/PM distortion. The real to logarithmic converter 534 simply converts the real signal to a logarithmic signal. The output signal from the real to logarithmic converter 534 is used to select the entry in the AM/PM table lookup block 536. The phase value read from the lookup table is converted into a complex conjugate phasor signal through multiplier block 538 and phase calculator 540. The generated AM/PM phase rotation, −ĝ(R(t)), is coupled to the AM/AM amplitude distortion, \hat{f}(R(t)). The final inverse (complex gain) AM/AM and AM/PM characteristics, \hat{f}⁻¹[R(t)]e^{-jĝ[R(t)]}, is formed through the multiplier 528 and multiplied by the in-coming signal, x(t), in the multiplier 530 to produce the instantaneous pre-distorted signal, y(t).

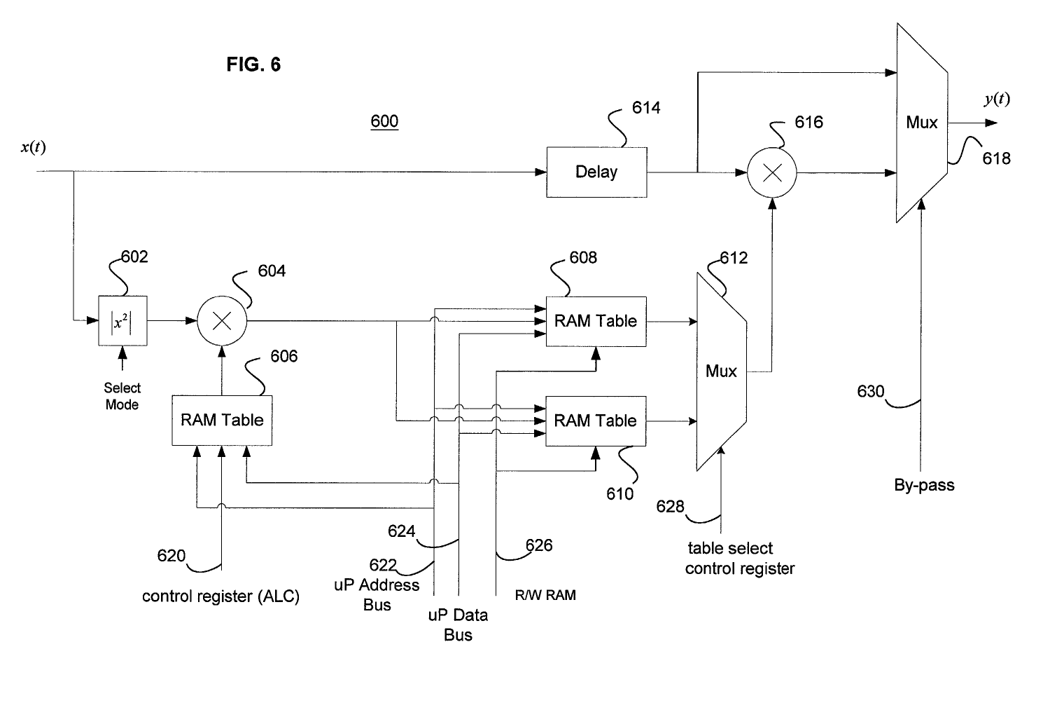

FIG. 6 illustrates an implementation of a digital pre-distorter 600. In this embodiment, no feed back path is provided. Thus, the embodiment of FIG. 6 corresponds to a non-adaptive lookup table based algorithm. Assuming that the intermediate frequency (IF) filter chain of the filter does not introduce too much memory effect for the transmitting signals, the lookup table algorithm could compensate the nonlinearity very well and its implementation is relatively simple.

The digital pre-distorter 600 includes a power estimator 602, a multiplier 604, a lookup table 606, a first lookup table 608, a second lookup table 610, a multiplexer 612, a delay block 614, a multiplier 616 and a multiplexer 618. The digital pre-distorter 600 receives an input signal x(t) and produces a pre-distorted signal y(t). The power estimate produced by the power estimator 602 is multiplied by a value from the lookup table 606. This value is indexed or selected in response to data provided on a control register line 620, a processor address bus 622 and a processor data bus 624. The output of the multiplier 604 is provided to the first lookup table 608 and the second lookup table 610 along with the data on the processor address bus 622 and the processor data bus 624 to select values stored in the lookup tables 608, 610. The selected values are provided to the multiplexer 612. The multiplexer 612 operates as a switch in response to a signal from a table select control register on a table select line 628 to selectively apply a value from one of the first lookup table 608 and the second lookup table 610 to the multiplier 616. The multiplier 616 multiplies the value by the delayed input signal x(t), which was delayed in the delay block 614.

The output of delay block 614 and the output of the multiplier 616 are provided to the multiplexer 618. The multiplexer selects one of the delayed input signal and the pre-distorted signal in response to the value of the by-pass signal on the by-pass line 630. The by-pass signal allows the pre-distorter 600 to be bypassed, with no effect produced on the input signal x(t).

As noted, the input signal x(t) is provided to the power estimator 602. The modulated signal power is first evaluated in the power estimator 602 and is used for indexing the entries of the inverse lookup tables 608, 610. The lookup tables 608, 610 are preferably formed of random access memory (RAM).

To make the pre-distorter more flexible, the power estimator 602 in one embodiment can be operated in one of four different modes. These operational modes are described below.

Mode (1): if the by-pass signal on the by-pass line 630 and coupled to the multiplexer 618 is high, the power estimator 602 is by-passed and the modulated signal will not be distorted and will be passed to the next signal processing blocks through the delay block 614 and the multiplexer 618.

Mode (2): is the normal operation where the amplitude (power) signal is estimated through the power estimator 602 based on the relation

$$\frac{\{ {Re [ x ( t ) ]}^{2} + {Im [ x ( t ) ]}^{2} \}}{2}$$

or other suitable calculation or estimation.

Mode (3): the pre-distorter 600 works at the so-called XY-squared mode. The pre-distorter 600 will get the table address by calculating first the real part of the input signal, Re[x(t)]², and then the imaginary part Im[x(t)]² of the input signal. The result of the calculation is a portion of the table address that can be combined with the values on the processor address bus 622 and the processor data bus 624 to access one or more values stored in the lookup tables 608, 610.

Mode (4): the pre-distorter 600 works at the YX-squared mode. The pre-distorter 600 gets the table address by first calculating the imaginary part Im[x(t)]² of the input signal and then calculating the real part Re[x(t)]² of the input signal.

The table select bits on the table select line 628 are used to select the dedicated lookup table from among the first lookup table 608 and the second lookup table 610. Furthermore, since the characteristics of the HPA may vary for different operating characteristics such as working temperatures, in the illustrated embodiment two lookup tables 608, 610 are implemented. The first lookup table 608 is used as a working lookup table. The second lookup table 610 is used to for updating by the control system of the transmitter, such as the medium access control layer (MAC), if the distortion characteristics of the HPA are changed beyond a pre-determined range due to temperature or other operational variations. The two lookup tables 608, 610 preferably are formed of two RAM devices which share the same data and address bus from the microprocessor. One of the two RAM devices is selected by writing data to a table selection control register. The table selection control register is written by MAC. The selected table content is a function of measured temperature of the HPA device. There are M different tables available to be downloaded to the second RAM depending on the HPA characteristics and the measured temperature.

The lookup table 606 forms an automatic level control (ALC) register. The lookup table 606 stores a power level setting which controls the power level at the input of the HPA. The value used by the pre-distorter 600 is controlled through data provided on the control register line 620 to the automatic level control (ALC) register. The ALC register value is scaled by the multiplier 604. The resulting signal is used to index the entries of lookup tables 608 and 610, respectively. The multiplexer 612 selects between a working lookup table and the one updated by the medium access control layer (MAC) if significant changes on the HPA characteristics is detected.

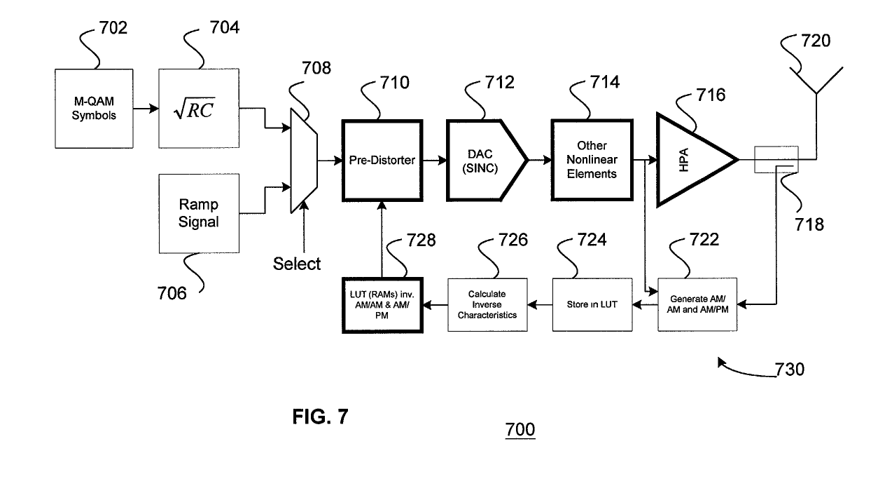

FIG. 7 is a block diagram of a calibration system 700 for generating entries for the pre-distorter table lookup RAMs. FIG. 7 illustrates the calibration setup required for a feedforward embodiment of a pre-distorter.

The calibration system 700 includes a source 701 of M-ary quadrature amplitude modulation symbols (M-QAM) 702, filter 704, a ramp signal source 706, a multiplexer 708, a pre-distorter 710, a digital to analog converter (DAC) 712, other non-linear element 714 and a high power amplifier (HPA) 716. A coupler 718 samples the output signal which is provided to an antenna 720. A feedback loop 730 includes a generator block 722, a storing block 724, a calculating block 726 and a look up table 728.

In the illustrated embodiment, the modulated signal is quadrature amplitude modulated (QAM), although the methods and apparatus of the current invention are not limited to any modulation format. For generation of AM/AM and AM/PM behavior of a high power amplifier (HPA) 716, a ramp signal from the ramp signal source 706 is used to drive the amplifier 716. The multiplexer 708 is used to switch the input signal back to the QAM modulation format.

As noted, the output signal of the HPA 716 is sampled through the directional coupler 718. Based on the ramp signal from the ramp signal source 706 and the generated output signal from the HPA 716, the AM/AM and AM/PM characteristics of the power amplifier are generated in generator block 711 and stored in storing block 710. The inverse modeling operation generates the inverse characteristics, \hat{f}⁻¹(.) and −ĝ(.) corresponding to amplitude and phase distortions ofthe HPA 716. In one embodiment, the inverse characteristics \hat{f}⁻¹(.) correspond to AM/AM data. In this embodiment, the AM/AM data are mathematically inverted as a 1/f(.) operation. In one embodiment, some of the AM/AM data are compressed or flattened to limit the dynamic range of the \hat{f}⁻¹(.) characteristics. The −ĝ(.) characteristics in one embodiment are formed by negating the AM/PM data or multiplying by −1. Data describing these curves are stored in the lookup table 728. In general, M different tables may be generated based on M different temperature-dependent distortion characteristics of the amplifier. A single lookup table or multiple lookup tables may be used to implement the lookup table 728.

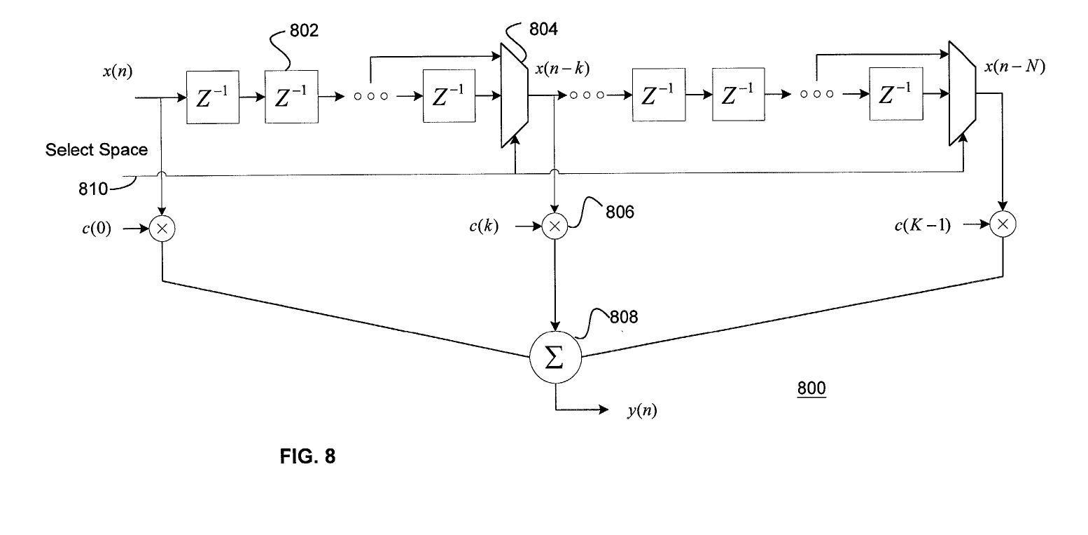

FIG. 8 is a block diagram of a programmable non-adaptive fractionally-spaced pre-equalizer 800. The pre-equalizer 800 includes a plurality of delay element 802, one or more multiplexers 804, multipliers 806 and a summer 808.

The pre-equalizer 800 has a finite impulse response (FIR) structure wherein the number of the delay element 802 (within a symbol) is selectable through a multiplexer 804 via the control signal labeled Select Space received on a control line 810. There are K tap multipliers blocks 806 and one summer 804. The overall pre-equalizer 800 can be programmed to have N different tap coefficient sets each corresponding to a different operating frequency range. This feature is primarily provided to account for any possible frequency dependency of the linear characteristics of the RF components.

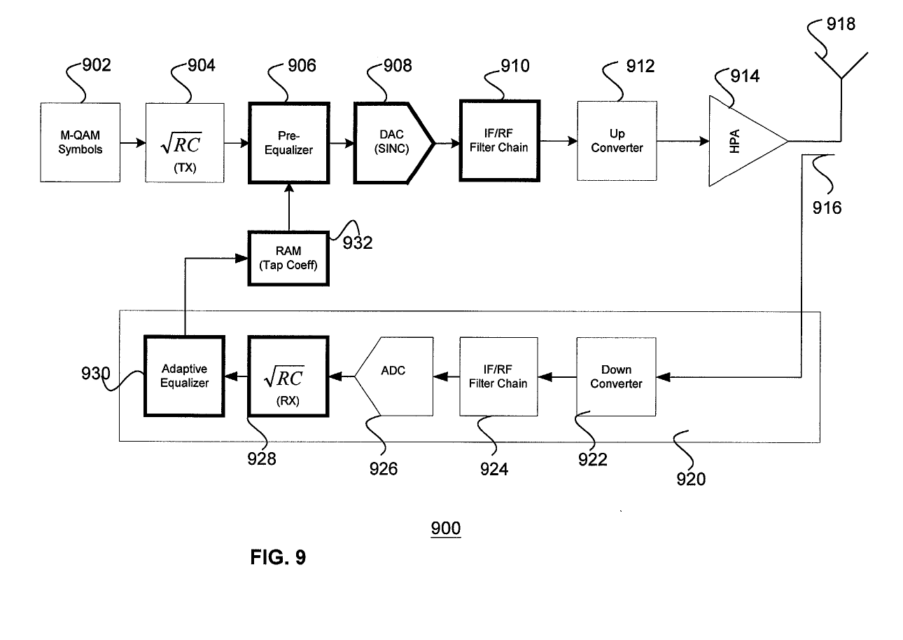

FIG. 9 is a block diagram of a calibration system 900 for the pre-equalizer of FIG. 8. FIG. illustrates the calibration setup required to generate the tap coefficient values for the pre-equalizer system 800 (FIG. 8). The calibration system 900 includes an M-QAM symbol source 902, a transmit filter 904 and the pre-equalizer 906, which may be embodied as the pre-equalizer 800 of FIG. 8. The calibration system 900 for calibrating the equalizer 906 includes a digital to analog converter (DAC) 908, an intermediate frequency to radio frequency (IF/RF) filter chain 910, an up-converter 912 and the high power amplifier (HPA) 914. The output signal from the HPA 914 is sampled by a coupler 916 at the output of the HPA 914 which is also coupled to drive an antenna 918. A feedback loop 920 includes a down-converter 922, an IF to RF filter chain 924, an analog to digital converter (ADC) 926, a receive filter 928 and an adaptive equalizer 930. Tap coefficients are stored in a memory 932.

The modulated signal from the symbol source 902 is first square-root raised-cosine pulse shaped by the transmit filter 902. The pre-equalizer block 906 is initially inactive or by-passed. The digital transmit signal is converted to an analog signal through the DAC 908. The impact of the retum-to-zero pulse formatting of the DAC is also included in the RF filter chain. A matching square-root raised-cosine filter receive 928 is added prior to an auxiliary adaptive equalizer to account for the transmitter counter-part filter 904. The adaptive equalizer or filter 930 in the illustrated embodiment is a linear fractionally-spaced equalizer that is used to generate the required tap coefficient sets for the pre-equalizer 906. In general, N tap coefficient sets can be generated for any possible dependency of the linear transfer function of overall component chain on the operating frequency.

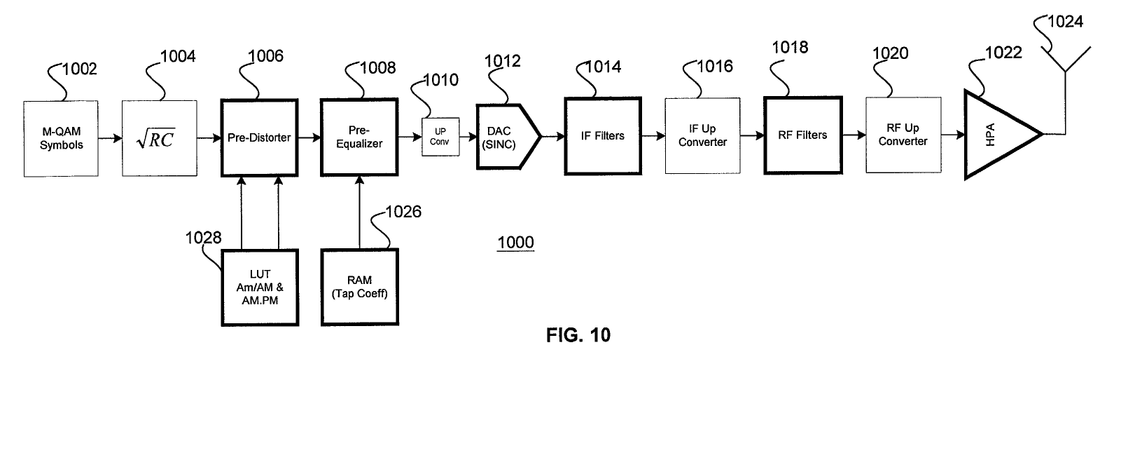

FIG. 10 is a block diagram showing a transmitter circuit 1000 including a pre-distorter block 1006 and a pre-equalizer block 1008. The transmitter circuit includes a modulator block 1002 and the transmitter square-root raised-cosine filter 1004 to generate the desired signal. It is to be noted hat the illustrated embodiment is independent of any modulation format. However, the illustrated embodiment may be well adapted to use in a link hopping radio system having a mesh architecture of the type illustrated in FIG. 3 and employing M-QAM.

The transmitter circuit 1000 further includes a pre-distorter 1006 and a pre-equalizer 1008. The pre-distorter 1006 may be embodied in any suitable form but the pre-distorter 500 of FIG. 5 and the pre-distorter 600 of FIG. 6 are particularly well adapted to this application. The pre-distorter 1006 is operated in conjunction with the lookup table (LUT) 1028. The pre-equalizer may be embodied in any suitable form but the pre-equalizer 800 of FIG. 8 is particularly well adapted to this application. The pre-equalizer 1008 is operated in conjunction with a tap coefficient memory 1026.

The transmitter circuit 1000 further includes an up-converter 1010, a digital to analog converter (DAC) 1012, intermediate frequency (IF) filters 1014, an IF up-converter 1016, radio frequency (RF) filters 1018, an RF up-converter 1020 and a high-power amplifier (HPA) 1022 to drive an antenna 1024.

In operation, the pre-distorter 1006 receives filtered digital symbols for transmission. The pre-distorter introduces distortion to compensate for non-linearities of the HPA 1020 as described herein. The up converter 1010 increases the frequency of the data from baseband to an intermediate frequency. The DAC 1012 converts digital data to an analog signal.

The IF filters 1014 filter the analog IF signal, for example, removing the image signal produced during up-conversion. The IF up-converter 1016 increase the frequency of the analog signals to radio frequency range. The RF filters 1018 remove undesired signal components from the transmit signal. The RF up-converter again increases the frequency of the transmit signal to the desired radio frequency for transmission, tuned to the required transmission frequency. The transmit signal is applied to the HPA 1022 to drive the antenna 1024.

The lookup table (LUT) 1028 contains the inverse model of the AM/AM and AM/PM characteristics of the nonlinear elements of the transmitter circuit. 1000. The LUT 1028 can be updated and selected based on the prescribed link power management strategy For example, in the exemplary embodiment of FIG. 3, based on information about the node which is transmitting and the node or nodes which are receiving, the transmission power requirement at a given time is known. As the transmitter hops from link to link, a different transmit power level may be required. If the high power amplifier operating point changes, the table and the entry within the table will change. The pre-equalizer 1008 tap coefficients can be updated through the tap coefficient memory 1026. The pre-distorter block 1006 accounts for nonlinear distortion of the transmit link including the HPA block 1011, the mild nonlinearities in the DAC block 1010 and other possible nonlinear analog components preceding the HPA. The pre-equalizer block 1008 compensates for the amplitude and group delay variations of the linear portion of the overall transmit chain prior to the antenna 1024 including the return-to-zero pulse shaping filtering of the DAC block 1012.

The operational blocks illustrated in FIG. 10 may be implemented using any appropriate hardware, software operating in conjunction with hardware elements or a combination of hardware and software. The system 1000 operates under control of data and instructions received from the medium access layer (MAC layer) of the transmitter incorporating the pre-distorter 1006 and pre-equalizer 1008. The medium access layer (MAC) provides scheduling operations, control of resources, and so forth. Since the updating operation required for the pre-distorter and/or pre-equalizer of the system 1000 does not happen relatively rapidly, some portions of the operations illustrated in FIG. 10 may be suitably implemented in software under control of the MAC layer and microprocessor.

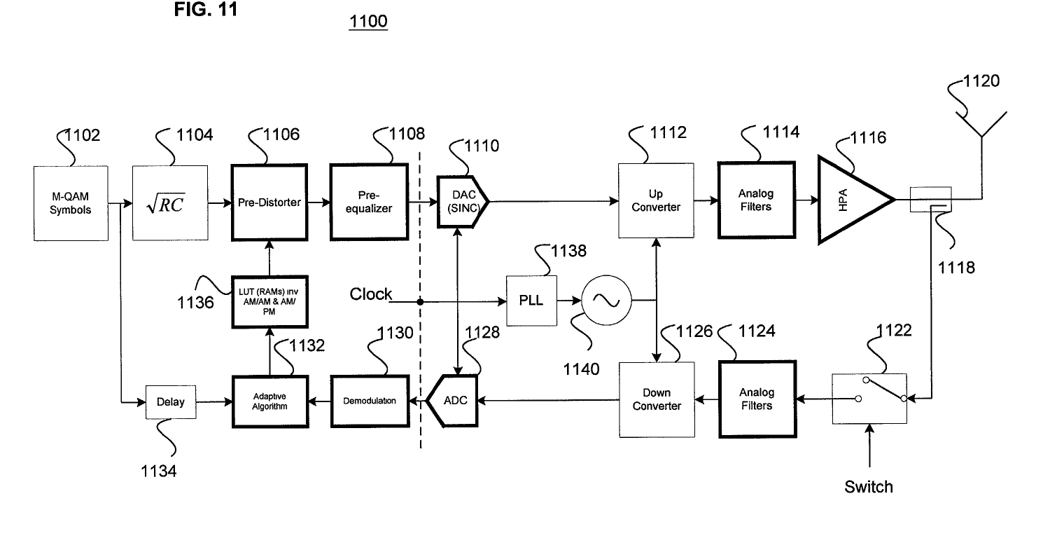

An alternative embodiment of a transmitter circuit 1100 is illustrated in FIG. 11. The transmitter circuit 1100 includes feedforward and feedback paths, respectively. The feedforward path includes a modulator block 1102, a square-root raised-cosine filter 1104, a pre-distorter 1106, a pre-equalizer 1108, a digital-to-analog converter (DAC) 1110, RF/IF up-converters 1112, analog linear filter chain 1114, and a high power amplifier (HPA) 1116 driving an antenna 1120. A feedback path or loop includes a directional coupler 1118, a switch 1122, a receive filter chain 1124, RF/IF down converters 1126, an analog to digital converter (ADC) 1128, a demodulator 1130, and an adaptive system 1132. The adaptive system 1132 in one embodiment is configured as a digital signal processor operating according to a software program code. The adaptive system 1132 can operate continuously (per sample) or intermittently every L symbols. The switch 1122 forms a means for switching out the feedback path from the rest of the circuit. The receive filter chain 1124 form cascaded filter means for band limiting and conditioning the sampled output signal from the directional coupler. The RF/IF down converters 1126, along with the analog to digital converter (ADC) 1128 and the demodulator 1130 form a means for RF down conversion to baseband, analog-to-digital conversion, digital demodulation and symbol detection to provide a refined feedback signal to the adaptive algorithm of the adaptive system block 1132 for updating the complex coefficient for the pre-distorter amplitude and phase lookup table blocks.

The output of the modulation block 1102 is coupled to the adaptive system through a delay block 1134 to generate the error signal employing an iterative algorithm such as a least-square adaptive technique. In one embodiment, the adaptive system 1132 includes a simple gradient adaptation algorithm. The adaptation algorithm for the pre-distorter 1106 is described as follows. The complex input and output signals for the pre-distorter 1106 are denoted by R(n)e^{jθ(n)} and r(n)e^{jφ(n)}, respectively.

The amplitude and the phase of the output signal of the HPA 1116 can be expressed as:

y(n)=f(r(n))e^{j[φ(n)+g(r(n))]}

The iterative adjustment algorithm for the pre-distorter 1106 is described by the following equations:

r(n+1)=r(n)−α·{f[r(n)]−R(n)}, and

φ(n+1)=φ(n)−β·{g[r(n)]−θ(n)},

where α and β are scale factors controlling the rate of adjustment of the adaptive algorithms. The scale factor, α and β, are selected out of the Q pre-stored values (i.e., k=1, 2, . . . , Q). The selection of the scale factors is software controlled and is based on the estimated signal-to-noise ratio, SNR, at the output of the pre-equalizer 1108 and other side-channel information provided to the MAC layer. The selection of scale factors may be based on other channel performance factors or information. The alternative embodiment of the transmitter circuit 1100 is employed in conjunction with the pre-equalizer block 1008 and its corresponding tap coefficient memory to pre-compensate the linear amplitude and group delay distortion of the transmitter components.

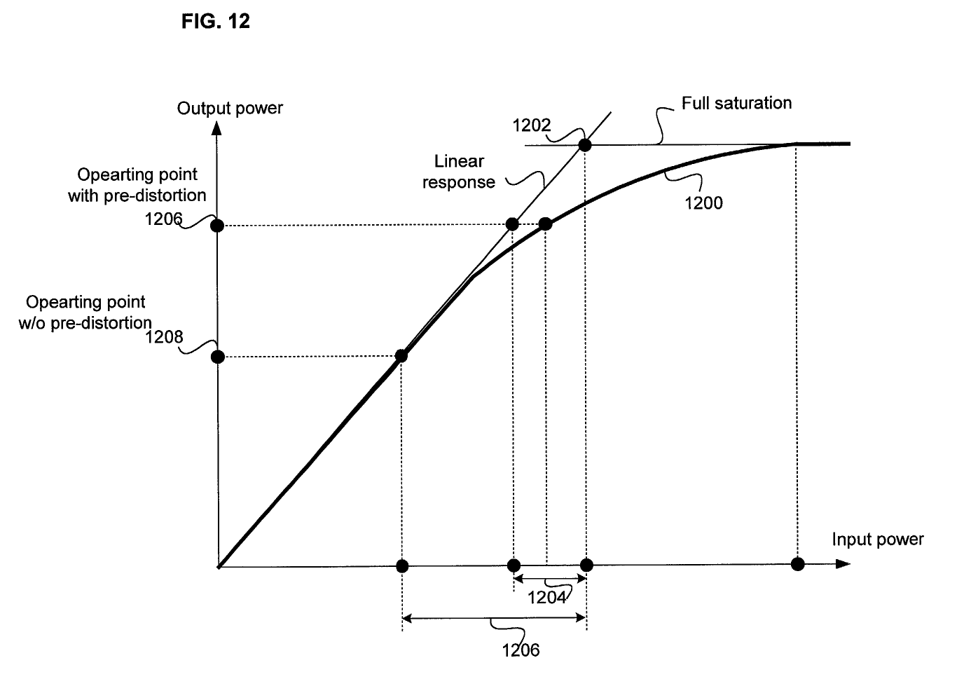

FIG. 12 illustrates the AM/AM characteristics 1200 of a typical high power amplifier before and after application of a digital pre-distorter of the type described herein. Ideally the desired output power should be at point 1202. This point provides maximum output power for a given input power, before saturation of the amplifier with the non-linearities saturation introduces. However, due to the non-constant envelope modulation format, an input back-off amount of 1204 is conventionally required. Hence, the output operating point after the pre-distorter is set at 1205. Without pre-distortion, the required back-off amount 1206 is much more and the output operating power should be set at point 120.

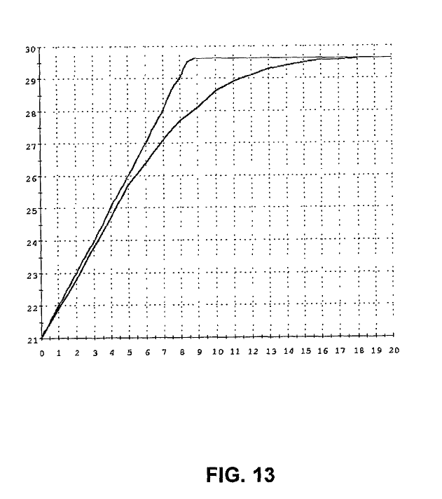

FIG. 13 illustrates the AM/AM characteristics of a high power amplifier used in conjunction with a pre-distorter as described herein. The linear response (after the pre-distorter) and the actual measured AM/AM distortion characteristic are shown in FIG. 13.

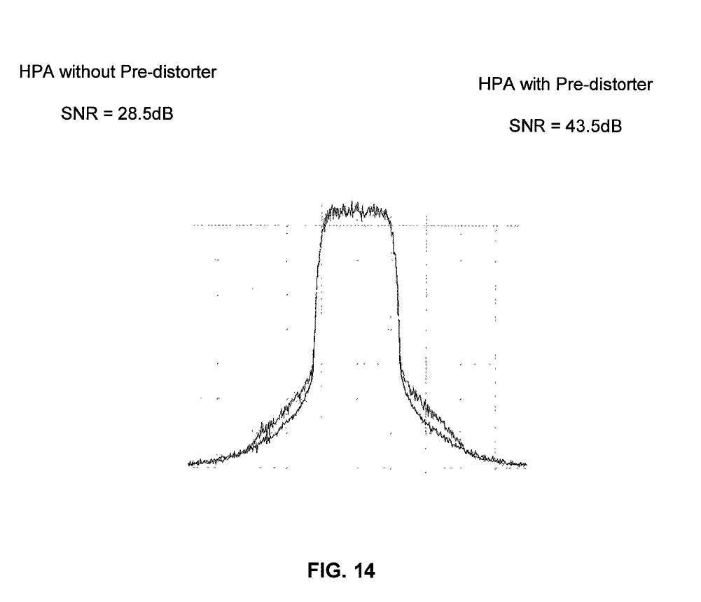

Finally, FIG. 14 illustrates the in-band and out-of-band distortion using a combined pre-distorter and pre-equalizer. As can be noted in an exemplary FIG. 14, spectrum plots of 256-QAM are shown with and without pre-distorter and pre-equalizer. The measured SNR without pre-distorter is around 28.5 dB. Where as, the measured SNR after the pre-distorter is about 43.5 dB. A significant improvement of around 15 dB is achieved with the present invention.

From the foregoing, it can be seen that the present embodiments provide a method and apparatus for a combined digital pre-distortion and pre-equalization employed in single- and/or multi-link burst systems. Information about the radio link, such as pre-distorter inverse AM/AM and AM/PM lookup table entries appropriate for the active link, are stored and/or update prior to the transmission of the next burst. In the present invention, first a pre-distorter block pre-distorts the transmit constellation symbols. The LUT contents and addresses are fully programmable. The contents of the LUTs may be updated if the HPA experiences a rather significant change in its distortion characteristics. A significant change in the temperature may require to use a different pre-stored inverse AM/AM and AM/PM look-up tables. A fixed pre-equalizer is used in conjunction with the pre-distorter to pre-compensate the linear amplitude and delay distortion of the front-end filters. The tap-coefficient weights are obtained from a calibration setup system that includes a matching square-root raised-cosine filter and an adaptive equalizer along with other required down converter, ADC and demodulation blocks. In the pre-equalizer calibration system, the HPA is operated in its linear region (low power) in order to have a negligible nonlinear impairment impact on the system performance. After the convergence of the adaptive equalizer the estimated tap coefficients are stored and down loaded into a RAM to provide the pre-equalizer weights.

While particular embodiments of the present invention have been shown and described, modifications may be made. The operational blocks shown in the block diagrams of the drawing may be embodied as hardware components, software code operating in conjunction with hardware, or a combination of the two. Implementation of such functions in hardware, software or a combination thereof is well within the purview of those ordinarily skilled in the appropriate art. Further, such illustrated functionality may be combined with other operations by way of modification. Accordingly, it is therefore intended in the appended claims to cover such changes and modifications that follow in the true spirit and scope of the invention.

What is claimed is:

1. A method for combined digital pre-equalizing and pre-distorting signal processing of radio signals from a transmitter to multiple receivers over nonlinear channels with memory, the method comprising:
transmitting packets of radio signals on a plurality of radio links in a radio system;
pre-distorting amplitude and phase of complex M-ary quadrature amplitude modulated (QAM) signal constellations generated for multiple radio links by the transmitter on the plurality of radio links using pre-distorter amplitude and phase lookup tables;
estimating and storing amplitude-amplitude (AM/AM) and amplitude-phase (AM/PM) characteristics of a nonlinear high-power amplifier through a calibration ramp signal as a function of M distinct ambient temperature values covering a desired dynamic operating temperature range;
pre-distorting an incoming QAM signal by a complex gain which is a function of operating point of the high-power amplifier (HPA);
pre-equalizing transmitted bursts of multiple radio links using a programmable fractionally-spaced pre-equalizer with tap coefficients obtained from a calibrated system using an adaptive equalizer placed after a matching receiver square-root raised-cosine filter coupled to the high-power amplifier (HPA); and
pre-equalizing amplitude and group-delay variations corresponding to composite transmit analog filters as well as distortion of digital-to-analog converter using K complex pre-stored tap coefficients.

2. The method of claim 1 further comprising:
pre-distorting the amplitude of transmitted complex QAM signaling burst on the plurality of radio links using pre-characterized and pre-stored AM/AM lookup tables that are addressed based on operating point of the high-power amplifier associated with an active link of the plurality of radio links.

3. The method of claim 2 further comprising:
extracting the linear behavior of the nonlinear amplifier from stored AM/AM characteristics by generating M pre-distorted amplitude lookup tables and M pre-distorted phase lookup tables corresponding to M different temperature values.

4. The method of claim 2 further comprising:
in a gain stage positioned prior to the high power amplifier of a signal path including the high power amplifier, setting a gain parameter value reflecting operating point of the high-power amplifier for the plurality of radio links.

5. The method of claim 2 further comprising:
selecting operating mode for addressing the amplitude lookup table based on one of squared magnitude of the incoming complex signal (x²+y²), real-squared magnitude (x²) and imaginary-squared magnitude (y²), wherein any operating mode could be used to get the appropriate table entry address for the stored pre-distorted AM/AM gain characteristics.

6. The method of claim 2 further comprising:
storing data in an additional lookup table, the data corresponding to characteristics of the high-power amplifier at different operating conditions of the high-power amplifier.

7. The method of claim 6 further comprising:
updating the data in the additional lookup table based on the stored characteristics of the high-power amplifier.

8. The method of claim 1 further comprising:
pre-distorting the phase of transmitted complex QAM signaling burst on the plurality of radio links using pre-characterized and pre-stored AM/PM lookup tables that are addressed based on operating point of the high-power amplifier associated with an active link of the plurality of radio links.

9. The method of claim 8 further comprising:
extracting the linear behavior of the nonlinear amplifier from stored AM/PM characteristics by generating M pre-distorted amplitude lookup tables and M pre-distorted phase lookup tables corresponding to M different temperature values.

10. The method of claim 8 further comprising:
in a gain stage positioned prior to the high power amplifier of a signal path including the high power amplifier, setting a gain parameter value reflecting operating point of the high-power amplifier for the plurality of radio links.

11. The method of claim 8 further comprising:
selecting operating mode for addressing the phase lookup table based on one of squared magnitude of the incoming complex signal (x²+y²), real-squared magnitude (x²) and imaginary-squared magnitude (y²), wherein any operating mode could be used to get the appropriate table entry address for the stored pre-distorted AM/PM gain characteristics.

12. The method of claim 8 further comprising:
storing data in an additional lookup table, the data corresponding to characteristics of the high-power amplifier at different operating conditions of the high-power amplifier.

13. The method of claim 1 further comprising:
providing a pre-equalizer block;
providing a pre-distorter block coupled with the pre-distorter amplitude and phase lookup tables;
providing a feedback path including
a directional coupler to sample an output signal of the high-power amplifier;
means for switching out the feedback path;
cascaded filter means for bandlimiting and conditioning the sampled output signal; and
means for RF down conversion to baseband, analog-to-digital conversion, digital demodulation and symbol detection to provide a refined feedback signal to an adaptive algorithm block for updating complex coefficients of the pre-distorter amplitude and phase lookup tables.

14. The method of claim 13 further comprising:
generating N sets of complex tap coefficients for the programmable fractionally-spaced pre-equalizer corresponding to N different desired operating frequency bands.

15. The method of claim 14 further comprising:
measuring frequency responses of the desired frequency bands; and
storing appropriate resulting tap coefficients according to operating frequency bands for a given link.

16. The method of claim 15 further comprising:
storing tap-coefficient sets in a shadow register in order to reduce the impact of inter-burst interference of adjacent bursts due to possible insufficient guard time between bursts when the transmitter is switching from burst to burst during per link operation, the shadow register being accessed when the span of pre-equalizer tap coefficients exceeds allowable guard time between bursts.

17. The method of claim 1 further comprising:
transmitting one or more packets on a first radio link; and
transmitting one or more packets on a second radio link.

18. The method of claim 17 further comprising:
retrieving stored pre-distortion data for the first radio link prior to transmitting on the first radio link;
retrieving stored pre-distortion data for the second radio link prior to transmitting on the first radio link; and
pre-distorting using the retrieved pre-distortion data.

19. The method of claim 17 further comprising:
retrieving stored pre-equalization data for the first radio link prior to transmitting on the first radio link;
retrieving stored pre-equalization data for the second radio link prior to transmitting on the second radio link; and
pre-equalizing using the retrieved pre-equalization data.

20. A radio transmitter comprising:
a high-power amplifier;
a signal amplitude and phase pre-distorter coupled with the high-power amplifier;
one or more lookup tables coupled with the pre-distorter to store pre-distorter data related to operating characteristics of the high-power amplifier; and
a pre-equalizer coupled with the pre-distorter and the high-power amplifier.

21. The radio transmitter of claim 20 further comprising:
a filter circuit; and
a digital to analog converter.

22. The radio transmitter of claim 21 wherein the pre-equalizer is configured to compensate for variations introduced by the filter circuit and the digital to analog converter:

23. The radio transmitter of claim 20 wherein the pre-distorter comprises:
a mode select input to receive a select mode signal.

24. The radio transmitter of claim 23 wherein the pre-distorter comprises:
a power estimator responsive to the mode signal for estimating power of an input signal.

25. The radio transmitter of claim 24 wherein the power estimator is configured to estimate power of the input signal according to one of
a squared magnitude of a complex input signal,
a real squared magnitude of the complex input signal, and
an imaginary squared magnitude.

26. The radio transmitter of claim 25 wherein the pre-distorter is configured to use the power estimate to index the lookup table.

27. The radio transmitter of claim 20 wherein the pre-distorter comprises:
an automatic level control register to store a power level settings, the power level settings being used to determine gain of the pre-distorter.

28. The radio transmitter of claim 20 further comprising:
a feedback path including an adaptive block, the adaptive block being configured to update the pre-distorter data stored in the one or more lookup tables.

29. A calibration method for a radio transmitter, the calibration method comprising:
(a) applying a calibration ramp signal to a pre-distorter of the radio transmitter;
(b) pre-distorting the calibration ramp signal to produce a pre-distorted signal;
(c) amplifying the pre-distorted signal in a high-power amplifier;
(d) sampling an output signal from the high-power amplifier;
(e) based on the calibration ramp signal and the sampled output signal, generating at least one of amplitude-to-amplitude and amplitude-to-phase characteristic data; and
(f) storing the characteristic data for subsequent use during operation of the radio transmitter.

30. The calibration method of claim 29 further comprising:
repeating acts (a) through (f) for different operating conditions of the radio transmitter.

31. The calibration method of claim 30 further comprising:
repeating acts (a) through (f) for different operating temperatures of the radio transmitter.

32. The calibration method of claim 29 wherein generating at least one of amplitude-to-amplitude and amplitude-to-phase characteristic data comprises:
determining an output signal due to the calibration ramp signal; and
based on the output signal, generating inverse data.

33. The calibration method of claim 29 wherein generating inverse data comprises:
inverting amplitude data to produce inverse AM/AM data; and
negating phase data to produce inverse phase data;

34. The calibration method of claim 29 wherein generating inverse data further comprises:
compressing some of the inverse AM/AM data to reduce dynamic range of the inverse AM/AM data.
